(19) United States
(12) Patent Application Publication
(10) Pub. No.: US 2010/0086799 A1
(43) Pub. Date: Apr. 8, 2010

(54) Removal method, adhesive agent for substrate, and laminate including substrate

(76) Inventors: Takahiro Asai, Kawasaki-shi (JP); Koichi Misumi, Kawasaki-shi (JP); Hirofumi Imai, Kawasaki-shi (JP)

Correspondence Address: WENDEROTH, LIND & PONACK, L.L.P., 1030 15th Street, N.W.,, Suite 400 East, Washington, DC, 20005-1503, US

(21) Appl. No.: 12/588,037

(22) Filed: Oct. 1, 2009

(30) Foreign Application Priority Data
Oct. 3, 2008 (JP) 258237/2008
Jun. 11, 2009 (JP) 140223/2009

(51) Int. Cl. B32B 9/04; B29C 63/00; B32B 23/04

(52) U.S. Cl. 428/532; 156/344; 428/411.1

(57) ABSTRACT

The removal method of the present invention includes: providing a support plate and a substrate being combined to each other via a first adhesive layer and a second adhesive layer, the second adhesive layer being an adhesive layer which is dissolvable in a solvent quicker than the first adhesive layer or an adhesive layer which is dissolvable in a solvent different from a solvent to which the first adhesive layer is dissolvable, and the second adhesive layer being between the support plate and the first adhesive layer; and removing the support plate from the substrate by dissolving the second adhesive layer. Further, the removal method of the present invention includes, after the step of removing, dissolving the first adhesive layer. This removes the support plate from the wafer in a quick and easy way.

This Nonprovisional application claims priority under 35 U.S.C. §119(a) on Patent Application No. 2008-258237 filed in Japan on Oct. 3, 2008, and on Patent Application No. 2009-140223 filed in Japan on Jun. 11, 2009, the entire contents of which are hereby incorporated by reference.

### TECHNICAL FIELD

The present invention relates to (i) a removal method for removing a support plate from a substrate to which the support plate is adhered, (ii) an adhesive agent for the substrate, and (iii) a laminate including the substrate.

### BACKGROUND ART

As a mobile phone, a digital AV device, an IC card, and the like product are improved in their functionality, it is increasingly demanded that a semiconductor chip (hereinafter referred to as a chip) which is to be mounted be downsized and thinned, so that the chip can be integrated in a package with higher density. In order to achieve high-density integration of the chip in the package, it is necessary to thin a thickness of the chip to a range from 25 to 150 μm.

However, a semiconductor wafer (hereinafter referred to as a wafer) from which the chip is produced is ground to have a thinner thickness and thereby has a weaker strength. As such, a crack is more likely to be formed in the wafer, or the wafer is more likely to be curbed. In addition, it is difficult to automatically transport the wafer having the weaker intensity due to the thin thickness. As such, it is required to manually transport the wafer, and thus, handling of the wafer becomes complex.

Accordingly, a wafer support system is developed in which the wafer to be thinned is adhered with a plate (so called a support plate) made of glass, rigid plastic, or the like material in order to maintain the strength of the wafer. This prevents formation of the crack and curbing of the wafer. Because the strength of the wafer can be maintained by the wafer support system, it is possible to automatically transport the thinned semiconductor wafer.

The wafer and the support plate are combined with each other via an adhesive tape, a thermal plasticity resin, an adhesive agent, and the like. The wafer thus combined with the support plate is thinned, and then, the support plate is removed from the substrate before dicing the wafer. For example, in a case where the wafer and the support plate are combined with each other via the adhesive agent, the adhesive agent is dissolved so as to remove the support plate from the wafer.

Conventionally, in order to remove the support plate from the wafer by dissolving the adhesive agent, it takes some time to, for example, diffuse a solvent into the adhesive agent and dissolve the adhesive agent into the solvent. As a result, it takes long time to remove the support plate from the wafer. In order to solve such a problem, Patent literature 1 discloses a method which uses an adhesive agent allows easy peeling.

The patent literature 1 discloses an art in which workpieces are adhered together with an adhesive agent having a first adhesive layer and a second adhesive layer on the first adhesive layer, the first adhesive layer being formed from a first adhesive material in which thermally-dissolvable microcapsule containing a release agent for reducing adhesibility of the first adhesive material is dispersed and the second adhesive layer being formed from a second adhesive material in which a thermally-expandable particle is dispersed.

The patent literature 1 teaches that the workpieces adhered together with the adhesive agent can be removed from each other by heating the adhesive agent so as to introduce the release agent from the microcapsule into the first adhesive layer and crack the first adhesive layer and the second adhesive layer due to a pressure by heat expansion of the thermally expandable particle. This allows separating the workpieces without leaving a residue of the adhesive agent on the workpieces.

Citation List

Patent Literature 1

Japanese Patent Application Publication, Tokukai, No. 2008-94957 A (Publication Date: Apr. 24, 2008)

### SUMMARY OF INVENTION

### Technical Problem

For removal of the support plate from the thinned wafer, it is necessary to make sure that the thinned wafer will not be damaged. By the method disclosed in the patent literature 1, however, there is a high probability that the wafer is damaged due to the heat treatment and the pressure by the heat expansion of the thermally expandable particles. Further, the method suffers problems in that the release agent contaminates the wafer and that the heat expandable particles in the adhesive layer reduces adhesibility of the adhesive layer. As such, there is a demand for (i) development of a removal method which makes it possible to remove the support plate from the wafer in a quick and easy way without damaging or contaminating the wafer, and (ii) development of an adhesive agent for use in the removal method.

The present invention is made in view of the problem, and an object of the present invention is to provide a removal method, a laminate, and an adhesive agent, each of which makes it possible to remove the support plate from the wafer in a quick and easy way.

### Solution to Problem

A removal method according to the present invention is a removal method for removing a support plate from a substrate, the removal method including: providing the support plate and the substrate being combined to each other via a first adhesive layer and a second adhesive layer, the second adhesive layer being (i) an adhesive layer which is dissolvable in a solvent quicker than the first adhesive layer or (ii) an adhesive layer which is dissolvable in a solvent different from a solvent to which the first adhesive layer is dissolvable, and the second adhesive layer being between the support plate and the first adhesive layer; and removing the support plate from the substrate by dissolving the second adhesive layer.

A laminate according to the present invention includes: a substrate; a first adhesive layer formed on the substrate; a second adhesive layer formed on the first adhesive layer, the second adhesive layer being (i) an adhesive layer which is dissolvable in a solvent quicker than the first adhesive layer or (ii) an adhesive layer which is dissolvable in a solvent different from a solvent to which the first adhesive layer is dissolvable; and a support plate attached on the second adhesive layer.

An adhesive agent according to the present invention is an adhesive agent for constituting a second adhesive layer included in the laminate.

### Advantageous Effects of Invention

The removal method according to the present invention is the removal method includes: providing the support plate and the substrate being combined to each other via a first adhesive layer and a second adhesive layer, the second adhesive layer being (i) an adhesive layer which is dissolvable in a solvent quicker than the first adhesive layer or (ii) an adhesive layer which is dissolvable in a solvent different from a solvent to which the first adhesive layer is dissolvable, and the second adhesive layer being between the support plate and the first adhesive layer; and removing the support plate from the substrate by dissolving the second adhesive layer. Therefore, with the removal method according to the present invention, it is possible to remove the support plate from the substrate in a quick and easy way.

### BRIEF DESCRIPTION OF DRAWINGS

FIG. 1

FIG. 1 is a cross sectional view showing a laminate 1 in accordance with one embodiment of the present invention.

FIG. 2

FIG. 2 is a cross sectional view showing the removal method in accordance with one embodiment of the present invention, in which (a) through (e) show steps of the removal method, respectively.

### DESCRIPTION OF EMBODIMENTS

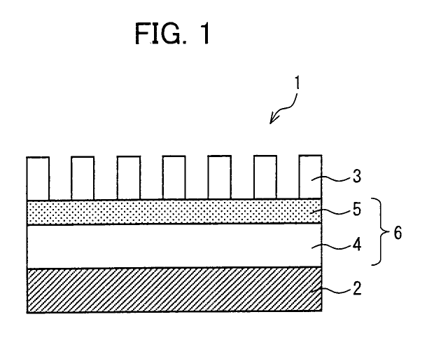

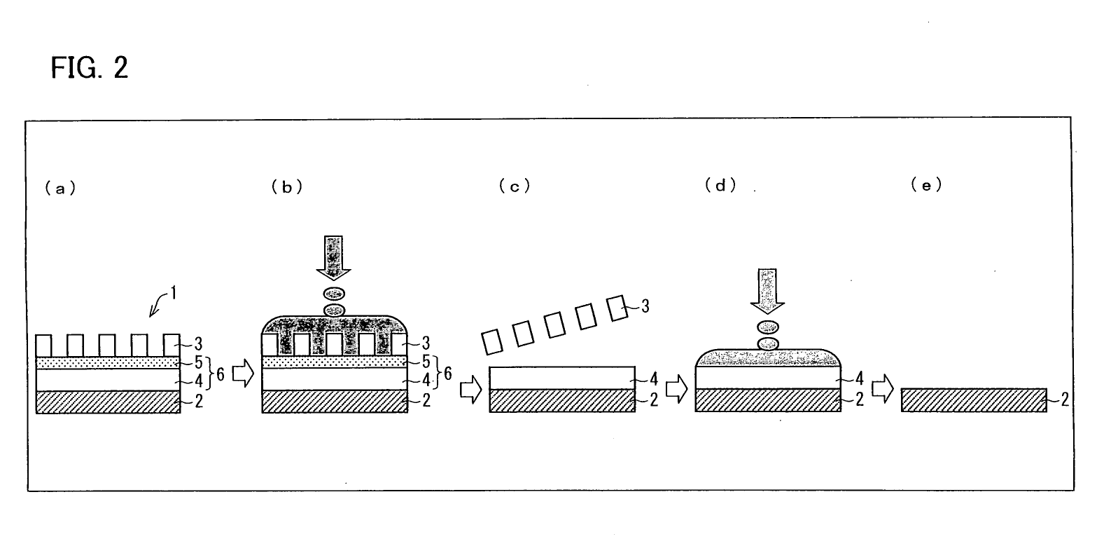

One embodiment of a removal method of the present invention is described below with reference to FIGS. 1 and 2. FIG. 1 is a cross sectional view showing a laminate 1 of the present invention for use in the removal method of the present invention. FIG. 2 is a cross sectional view showing the removal method in accordance with one embodiment of the present invention, in which (a) through (e) show steps of the removal method, respectively. As shown in FIG. 1 and (a) through (e) of FIG. 2, the laminate 1 includes a wafer (substrate) 2, a support plate 3, a first adhesive layer 4, and a second adhesive layer 5. In the laminate 1, the first adhesive layer 4 and the second adhesive layer 5 constitute an adhesive laminate 6, which combines the wafer 2 and the support plate 3.

The removal method of the present invention is a method which includes: providing the support plate 3 and the wafer 2 being combined to each other via the first adhesive layer 4 and the second adhesive layer 5, the second adhesive layer 5 being an adhesive layer dissolvable in a solvent quicker than the first adhesive layer 4 or an adhesive layer dissolvable in a solvent different from a solvent to which the first adhesive layer 4 is dissolvable, and the second adhesive layer being between the support plate 3 and the first adhesive layer 4; and removing the support plate 3 from the wafer 2 by dissolving the second adhesive layer 5.

In the present embodiment, the support plate 3 is a pored support plate 3 having through-holes in a thickness direction. However, the present invention is not limited to this. Use of the pored support plate 3 allows supplying the solvent to the second adhesive layer 5 via the through-holes.

(First Adhesive Layer 4)

The first adhesive layer 4 adheres to the wafer 2 and the second adhesive layer 5. The first adhesive layer should be formed by a first adhesive material which is made from an adhesive compound capable of adequately combining the wafer 2 and the support plate 3 via the second adhesive layer 5. The first adhesive material may be a conventionally well-known adhesive material. Examples of the first adhesive material constituting the first adhesive layer 4 encompass a material made from an acrylic-styrene-type resin, a material made from a maleimide-type resin, and a material made from the like resin.

Examples of acrylic-styrene-type resin encompass a resin which is obtained by polymerizing monomers such as (i) styrene or a derivative of styrene, (ii) (meth)acrylic acid ester and/or the like.

Examples of (meth)acrylic acid ester encompass (meth)acrylic acid alkyl ester having a chain structure, (meth)acrylic acid ester having an aliphatic ring, and (meth)acrylic acid ester having an aromatic ring. Examples of (meth)acrylic acid alkyl ester having the chain structure encompass acrylic-type long-chained alkyl ester having a carbon number in a range from 15 to 20, acrylic-type alkyl ester whose alkyl group has a carbon number in a range from 1 to 14, and the like acrylic-type alkyl ester. Examples of acrylic-type long-chained alkyl ester encompass acrylic acid alkyl ester and methacrylic acid alkyl ester, each having an alkyl group which is an n-pentadecyl group, an n-hexadecyl group, an n-heptadecyl group, an n-octadecyl group, an n-nonadecyl group, an n-eicosyl group, or the like group. Each of acrylic acid alkyl ester and methacrylic acid alkyl ester may have the alkyl group having a branched shape.

Examples of acrylic alkyl ester whose alkyl group has a carbon number in a range from 1 through 14 encompass well-known acrylic alkyl ester which is used in an existing acrylic adhesive agent. For examples, such acrylic alkyl ester encompasses acrylic acid alkyl ester and methacrylic acid alkyl ester, each having an alkyl group which is a methyl group, an ethyl group, a propyl group, a butyl group, a 2-ethyl hexyl group, an isoocyl group, an isononyl group, an isodesyl group, a dodecyl group, a lauryl group, a tridecyl group, or the like group.

Examples of (meth)acrylic acid ester having the aliphatic ring encompass cyclohexyl (meth)acrylate, cyclopentyl (meth)acrylate, 1-adamantyl (meth)acrylate, norbornyl (meth)acrylate, isobornyl (meth)acrylate, tricyclo decanyl (meth)acrylate, tetracyclododecanyl (meth) acrylate, dicyclopentanyl (meth)acrylate, and the like acrylate. Among them, isobornyl methacrylate and dicyclopentanyl methacrylate are more preferable.

(Meth)acrylic acid ester having the aromatic group is not particularly limited. Examples of the aromatic group encompass a phenyl group, a benzyl group, a tolyl group, a xylyl group, a biphenyl group, a naphthyl group, an anthracenyl group, a phenoxymethyl group, a phenoxyethyl group, and the like group. The aromatic group may have a chained alkyl group having a carbon number in a range from 1 through 5 or a branched alkyl group having a carbon number in a range from 1 through 5. Specifically, phenoxyethyl acrylate is preferable.

An example of the maleimide resin encompasses a resin which is obtained by polymerizing a monomer such as maleimide having an alkyl group, maleimide having an aliphatic hydrocarbon group, aromatic maleimide having an aryl group, or the like maleimide. Maleimide having the alkyl group may be N-methyl maleimide, N-ethyl maleimide, N-n-propyl maleimide, N-isopropyl maleimide, N-sec-butyl maleimide, N-tert-butyl maleimide, N-n-pentyl maleimide, N-n-hexyl maleimide, N-n-heptyl maleimide, N-n-octyl maleimide, N-lauryl maleimide, N-stearyl maleimide, or the like maleimide. Maleimide having the aliphatic hydrocarbon group may be N-cyclopropyl maleimide, N-cyclobutyl maleimide, N-cyclopentyl maleimide, N-cyclohexyl maleimide, N-cycloheptyl maleimide, N-cyclooctyl maleimide, or the like maleimide. Aromatic maleimide having the aryl group may be N-phenyl maleimide, N-m-methylphenyl maleimide, N-o-methylphenyl maleimide, N-p-methylphenyl maleimide, or the like maleimide.

A film thickness of the first adhesive layer 4 is preferably in a range from 15 to 30 μm, and is particularly preferably 15 μm, so that adhesion between the wafer 2 and the support plate 3 as well as thermal resistance will be maintained. However, the present invention is not limited to this. The first adhesive layer 4 can be formed by (i) applying, on the wafer 2, the first adhesive material made from the adhesive compound, and then (ii) hardening the first adhesive material into a layer on the wafer 2. Alternatively, the first adhesive layer 4 can be formed by (i) hardening the first adhesive material into a layer in advance and then (ii) transporting the layer onto the wafer 2.

(Second Adhesive Layer 5)

The second adhesive layer 5 is formed on the support plate 3, and combines the first adhesive layer 4 and the support plate 3. The second adhesive layer 5 is formed in such a manner as to be dissolved quicker than the first adhesive layer 4 or in such a manner as to be dissolved in a solvent different from a solvent to which the first adhesive layer 4 is dissolved. An adhesive agent of the present invention is for constituting the second adhesive layer 5, and is made of a second adhesive material described later.

The second adhesive layer 5, which is dissolved quicker than the first adhesive layer 4, is formed from the second adhesive component having a high dissolubility. The second adhesive layer 5 can be formed from the adhesive material whish is made from an adhesive compound having an average molecular weight smaller than that of the adhesive compound in the first adhesive material.

The second adhesive layer thus formed in such a manner as to be dissolved quicker than the first adhesive layer 4 allows the following. For removal of the support plate 3 from the wafer 2, the solvent is supplied to the second adhesive layer 5 via a through-hole in the support plate 3. As a result, the second adhesive layer 5 dissolvable quicker than the first adhesive layer 4 can be quickly dissolved in the solvent within a shorter time. This makes it possible to more quickly remove the support plate 3, which is combined with the wafer 2 via the second adhesive layer 5. The first adhesive layer 4 is to be dissolved after removing the support plate 3. Therefore, the support plate 3 will not hinder diffusion of the solvent into the first adhesive layer 4. This makes it possible to dissolve the first adhesive layer 4 also within a short time.

The second adhesive layer 5 dissolvable quicker than the first adhesive layer 4 is preferably formed from a second adhesive material made from an adhesive compound whose average molecular weight corresponds to 10 to 30% of the average molecular weight of the adhesive compound constituting the first adhesive layer 4. This makes it possible to obtain a dissolution rate at a sufficient level to shorten the removal time. In a case where the first adhesive layer 4 is formed by a conventionally-used typical first adhesive material, the second adhesive layer 5 should be formed from a second adhesive material made from an adhesive compound whose average molecular weight is in a range from 5000 to 10000. For example, in a case where the first adhesive layer 4 is formed from a first adhesive material made from an adhesive compound whose average molecular weight is 40000, the second adhesive layer 5 can be formed from a second adhesive material made of an adhesive compound whose average molecular weight is 10000.

The second adhesive layer 5 dissolvable in the solvent different from the one to which the first adhesive layer 4 is dissolvable is formed from a second adhesive material resistant to the solvent to which the first adhesive layer 4 is dissolvable. The above second adhesive layer 5 is preferably formed from the second adhesive material which has a high dissolution rate to the solvent different from the one to which the first adhesive layer 4 is dissolved.

The second adhesive layer 5 thus formed in such a manner as to be dissolved in the solvent different from the one to which the first adhesive layer 4 is dissolved allows the followings. For removal of the support plate 3 from the wafer 2, the solvent is supplied to the second adhesive layer 5 via the through-hole in the support plate 3. As a result, only the second adhesive layer 5 can be dissolved in the solvent to which the second adhesive layer. 5 is dissolvable. This makes it possible to remove the support plate 3, which is combined with the wafer 3 via the second adhesive layer 5. The first adhesive layer 4 is to be dissolved after removing the support plate 3. Therefore, the support plate 3 will not hinder diffusion of the solvent into the first adhesive layer 4. This makes it possible to dissolve the first adhesive layer 4 also in a quick way.

Because the pored support plate 3 is used in the present embodiment, a solvent (e.g., a back rinse agent for use in a photolithography process) may reach the second adhesive layer 5 via the though-hole in the support plate 3 during a thinning process for the wafer 2. However, a typical adhesive layer (such as the first adhesive layer 4) for combining the wafer 2 and the support plate 3 exhibits no resistance to a solvent made from an organic solvent PGMEA (propylene glycol monomethyl ether acetate), HP (2-heptanone), or the like. As such, in a case where such solvent reaches the typical layer via the through-hole in the support plate 3, the typical adhesive layer is dissolved. This results in delamination of the support plate 3 from the wafer 2, thereby causing a problem in that the thinning process can not be carried out in a good manner. In order to solve the problem, it is conventionally configured so that, during a process in which there is a risk that the solvent reaches the adhesive layer, the through-hole in the support plate 3 is sealed with a back tape so as to prevent the solvent from inflowing thereinto. However, such a configuration is not preferable because it leads to a deterioration of a processing efficiency and increasing of a cost.

In the present invention, the second adhesive layer 5 being resistant to the solvent made from the organic solvent as described above is formed onto the support plate 3, so that the first adhesive layer 4 is covered by the second adhesive layer 5. As such, even in a case where the solvent made of an organic solvent as described above diffuses via the through-hole in the support plate 3, neither the first adhesive layer 4 nor the second adhesive layer 5 is dissolved, thereby preventing delamination of the support plate 3 from the wafer 2. This makes it unnecessary to seal the through-hole in the support plate 3 with the back tape.

The second adhesive layer 5 should be dissolvable with the solvent different from the one to which the first adhesive layer 4 is dissolvable. In a case where the first adhesive layer 4 is formed by the first adhesive material dissolvable with an organic solvent, the second adhesive layer 5 should be formed by the second adhesive material being resistant to the organic solvent. An adhesive compound in such a second adhesive layer 5 can be a hydrocarbon resin or a polar-solvent dissolubility compound (e.g., water-dissolvable compound).

Examples of the hydrocarbon resin encompass (i) a cycloolefin polymer (hereinafter referred to as a “resin (A)”), (ii) at least one resin (hereinafter referred to as a “resin (B)”) selected from the group consisting of a terpene resin, a rosin resin, and a petroleum resin, and (iii) the like, to which the present invention is not limited.

The resin (A) is a resin which is obtained by polymerizing a monomeric component including a cycloolefin monomer (a1). Concrete examples of the resin (A) encompass: a monomeric compound open-ring (co)polymer including the cycloolefin monomer (a1); a resin to which the monomeric compound including the cycloolefin monomer (a1) is additionally (co)polymerized; and the like.

Examples of the cycloolefin monomer included in the monomeric compound composing the resin (A) encompass: bicyclics such as norborenen, norbornadiene, and the like; tricyclics such as dicyclopentadiene, dihydroxypentadiene, and the like; tetracyclics such as tetracyclododecene and the like; pentacyclics such as cyclopentadiene trimer and the like; heptacyclics such as tetracyclopentadiene and the like; a substituted alkyl (methyl, ethyl, butyl, or the like) of above polycyclics, a substituted alkenyl (such as vinyl or the like) thereof, a substituted alkylidene (ethylidene) thereof, a substituted aryl (phenyl, tolyl, naphthyl, or the like) thereof; and the like. Among them, a norbornene monomer selected from the group consisting of norbornene, tetracyclododecene, and a substituted alkyl of these and shown by the following general formula (1) is particularly preferable.

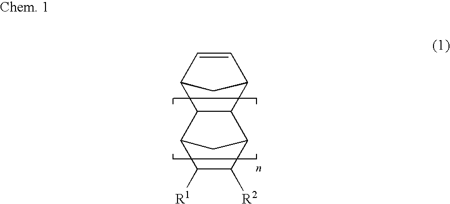

(where each of R¹ and R² is, independently, either a hydrogen atom or an alkyl group having a carbon number in a range from 1 through 6, and n=0 or 1)

The monomeric compound for constituting the resin (A) can include another monomer which is copolymerizable with the cycloolefin monomer (a1). For example, it is preferable that the above monomeric compound also include an alkene monomer (a2) shown by the following general formula (2). Examples of the alkene monomer encompass ethylene, propylene, 1-butene, isobutene, 1-hexene, α-olefin, and the like. The alkene monomer (a2) can be a linear monomer or a branched monomer.

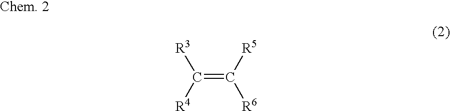

(where each of R³ through R⁶ is, independently, either a hydrogen atom or an alkyl group having a carbon number in a range from 1 through 4.)

The monomeric compound for constituting the resin (A) includes cycloolefin monomer (a1) preferably in a range of 50 mass % or more, and more preferably in a range of 60 mass % or more. In a case where the above monomeric compound includes the cycloolefin monomer (a1) in the range of 50 mass % or more of its total mass, an adhesive strength at high temperature will be good.

For prevention of gas generation at high temperature, it is preferable that the resin (A) be a resin having no polar radical, like a resin to be obtained by polymerizing the monomeric component such as the cycloolefin monomer (a1) shown by the general formula (1) and the alkene monomer (a2) shown by the general formula (a2).

Neither a polymerization method nor a polymerization condition for polymerizing the above monomeric components is particularly limited. The polymerization method and the polymerization condition should be set as appropriate by the law of the art.

Examples of a commercially available product which is usable as the resin (A) encompass “TOPAS” manufactured by Polyplastics Co., Ltd, “APEL” manufactured by Mitsui Chemicals, Inc, “ZEONOR” and “ZEONEX” manufactured by Zeon Corporation, “ARTON” manufactured by JSR Corporation, and the like product.

A glass transition point for the resin (A) is preferably 60° C. or higher, and particularly preferably 70° C. or higher. In a case where the resin (A) has the glass transition point of 60° C. or higher, the adhesive layer can be prevented from being softened even when an adhesive composition is exposed under high-temperature environment.

The resin (B) is at least one resin selected from the group consisting of a terpene resin, a rosin resin, and a petroleum resin. Concrete examples of the terpene-type resin encompass a terpene resin, a terpene phenol resin, a modified terpene resin, a hydrogenerated terpene resin, a hydrogenerated terpene phenol resin, and the like. Concrete examples of the rosin-type resin encompass a resin made from rosin, rosin ester, hydrogenerated rosin, hydrogenerated rosin ester, polymerized rosin, polymerized rosin ester, modified rosin, or the like. Concrete examples of the petroleum resin encompass an aliphatic or an aromatic petroleum resin, a hydrogenerated petroleum resin, a modified petroleum resin, an alicyclic petroleum resin, a coumarone-indene petroleum resin, and the like. Among them, the hydrogenerated resin and the hydrogenerated petroleum resin are preferable.

The resin (B) is not particularly limited in a softening point, but it is preferable that the resin (B) have the softening point in a range from 80 to 160° C. In a case where the resin (B) has the softening point in a range of 80° C. or higher, softening can be prevented even when the adhesive composition is exposed under high-temperature environment. Thus, an adhesion failure is prevented. On the other hand, in a case where the resin (B) has the softening point in a range of 160° C. or lower, a good removal rate of the adhesive composition is obtained.

The resin (B) is not particularly limited in molecular weight, but it is preferable that the resin (B) have the molecular weigh in a range from 300 to 3000. In a case where the resin (B) has the molecular weight in a range of 300 or greater, sufficient thermal resistance is obtained. As such, a degassing amount under high-temperature environment is decreased. On the other hand, in a case where the resin (B) has the molecular weight in a range of 3000 or less, a good removal rate of the adhesive composition is obtained. In the present invention, the molecular weight of the resin (B) is molecular weight based on polystyrene according to gel permeation chromatography (GPC).

A mixture of the resin (A) and the resin (B) can be used. The mixture of the resin (A) and the resin (B) provides a good thermal resistance and a good removal rate. For example, it is preferable that a mixing ratio (mass ratio) of the resin (A) and the resin (B) be in a range from 80:20 to 55:45 because this provides an excellent removal rate, thermal resistance to high-temperature environment, and flexibility.

Examples of the polar-solvent dissoluble compound encompass collagen peptide, cellulose, polyvinyl alcohol (PVA), amylum, and the like, to which the present invention is not limited.

Collagen peptide can be obtained by hydrolyzing collagen molecules whose helical structure formed of polypeptide strands has been partly loosened and thereby gelatinized due to thermal modification. Preferably usable examples of the collagen molecules are a mammal-derived collagen molecule and a fin-derived collagen molecule. The collagen molecules can be commercially available collagen molecules, but it is preferable that the collagen molecules be collagen molecules from which collagen peptide having a dissolution rate to a polar solvent of a range from 100 to 300 nm/sec can be obtained. It is particularly preferable that the collagen molecules be collagen molecules from which collagen peptide having a dissolution rate to the solvent of 200 nm/sec can be obtained.

For the second adhesive material to constitute the second adhesive layer 5, a material suitable with the treatment to be performed onto the laminate 1 should be selected as appropriate. For example, in a case where a large volume of water is used during the thinning process for the wafer 2, it is preferable to use a hydrocarbon resin as the second adhesive material because the second adhesive material made from a water-dissolvable compound constitutes the second adhesive layer 5 which is possibly dissolved in water.

It is preferable that the second adhesive layer 5 have a film thickness thinner than the first adhesive layer 4 and corresponding to 10 to 20% of a total film thickness of the adhesive laminate 6, so that (i) the adhesion between the wafer 2 and the support plate 3 and (ii) the thermal resistance will be maintained. However, the present invention is not limited to this. In a case where, for example, the first adhesive layer 4 has a film thickness of 15 μm, the second adhesive layer 5 can have a film thickness of 3 μm. The second adhesive layer 5 can be formed by: applying, onto the fist adhesive layer 4, the second adhesive material including the above adhesive compound; and hardening the second adhesive material into a layer on the first adhesive layer 4. The second adhesive layer 5 can be alternatively formed by: hardening the second adhesive material into a layer; and transporting the layer onto the first adhesive layer 4.

Alternatively, the first adhesive layer 4 and the second adhesive layer 5 can be formed by: applying a mixture of the first adhesive material and the second adhesive material onto the wafer 2; and hardening the mixture of the first adhesive material and the second adhesive material into two respective layers on the wafer 2. In this case, the first adhesive material and the second adhesive material should be selected from unmixable materials which are not emulsifiable with each other, and which form the first adhesive layer 4 on the wafer 2 and the second adhesive layer 5 on the support plate 3 due to a difference in molecular weight.

The laminate 1 of the present invention can be formed by: forming the first adhesive layer 4 on the wafer 2; forming the second adhesive layer 5 on the first adhesive layer 4; and then attaching the support plate 3 on the second adhesive layer 5. Alternatively, the laminate 1 of the present invention can be formed by: forming the second adhesive layer 5 on the support plate 3; forming the first adhesive layer 4 on the second adhesive layer 5; and then attaching the wafer 2 on the first adhesive layer 4. Also, the laminate 1 of the present invention can be formed by: forming the first adhesive layer 4 and the second adhesive layer 5 on the wafer 2 and the support plate 3, respectively; and combining the wafer 2 and the support plate 3 via the first adhesive layer 4 and the second adhesive layer 5.

With reference to (a) through (e) of FIG. 2, the following explains process flows of the removal method in accordance with the present invention. The removal method of the present invention should include at least the removal step described earlier. It is preferable that the removal method further include, after the removal step, the dissolution step for dissolving the first adhesive layer 4. The present embodiment explains, as an example, the removal method of the present invention which includes the dissolution step.

First, in the removal step of the present invention, the laminate 1 of the present invention, which is to be treated with the removal treatment, is prepared as shown in (a) of FIG. 2. Subsequently, as shown in (b) of FIG. 2, the solvent to which the second adhesive layer 5 is dissolvable is supplied from above the support plate 3. The supplied solvent inflows via a through-hole in the support plate 3, and diffuses into the second adhesive layer 5, thereby dissolving the second adhesive layer 5.

In this case, the solvent to which the second adhesive layer 5 is dissolved is selected as appropriate in accordance with a property of the second adhesive layer 5. In a case where the second adhesive layer 5 is formed by the second adhesive material made from an adhesive compound whose average molecular weight is less than that of the adhesive compound in the first adhesive material, the solvent to which the second adhesive layer 5 is dissolvable can be a same as the solvent to which the first adhesive layer 4 is dissolvable. Such solvent is preferably a solvent whose solubility parameter (SP value) is greater than 8 and smaller than 10. Examples of the solvent encompass PGMEA, HP, and the like.

On the other hand, in a case where the second adhesive layer 5 is formed from a hydrocarbon resin, a nonpolar solvent is preferably usable as the solvent. Examples of the nonpolar solvent encompass a hydrocarbon-type solvent and the like. Examples of the hydrocarbon-type solvent encompass a solvent having liner hydrocarbon, a solvent having branched hydrocarbon, or a solvent having cyclic hydrocarbon. A concrete example of linear hydrocarbon encompasses linear hydrocarbon such as hexane, heptane, octane, nonane, methyl octane, decane, undecane, dodecane, tridecane, and the like. A concrete example of branched hydrocarbon encompasses branched hydrocarbon whose carbon number is in a range from 3 through 15. A concrete example of cyclic hydrocarbon encompasses cyclic hydrocarbon (terpenes) such as monoterpenes and diterpenes. Monoterpenes encompasses geraniol, nerol, linalool, citral, citronellol, p-menthane, o-menthane, m-menthane, diphenyl menthane, menthol, isomenthol, neomenthol, limonene, α-terpinene, β-terpinene, γ-terpinene, α-terpineol, β-terpineol, γ-terpineol, terpene-1-ol, terpene-4-ol, 1,4-terpene, 1,8-terpene, carvone, ionone, thujone, camphor, bornane, borneol, norbornane, pinane, α-pinene, β-pinene, thujane, α-thujone, β-thujone, carane, camphor, longifolene, 1,4-cineol, 1,8-cineol, and the like. Diterpenes encompass abietane, abietic acid, and the like.

Above all, a terpene-type solvent whose hydrocarbon has a cyclic skeleton is used preferably. In particular, it is preferable that the terpene-type solvent be a monoterpene, because monoterpenes are easily available. Above all, a monoterpene selected from limonene, pinene, pinane, and p-menthane is preferable because each of the above monoterpenes shows a high solving ability. Above all, a nonpolar solvent whose SP value is 8 or lower is preferably usable. It is more preferable that a nonpolar solvent whose SP value is 7.4 or lower be used.

Moreover, in a case where the second adhesive layer 5 is made from a polar-solvent dissolvable compound (e.g., water-dissolvable compound), a conventionally well-known polar solvent is preferably usable as the solvent. In this case, it is preferable that a polar solvent having an SP value of 10 or greater be used, and more preferable that a polar solvent having an SP value of 12 or greater be used. Examples of the solvent having the SP value of 12 or greater encompass water, methanol, ethanol, isopropyl alcohol, and the like.

Next, as shown in (c) of FIG. 2, the support plate 3 is removed after dissolving the second adhesive layer 5. After removal of the support plate 3, a residue of the second adhesive layer 5 which is failed to be dissolved away can be removed by washing the first adhesive layer 4.

Subsequently, as shown in (d) of FIG. 2, the solvent to which the first adhesive layer 4 is dissolvable is poured onto an entire surface of the first adhesive layer 4, so as to dissolve the first adhesive layer 4. As shown in (e) of FIG. 2, this can produce the wafer 2 from which the support plate 3, the first adhesive layer 4, and the second adhesive layer 5 have been removed. The solvent to which the first adhesive layer 4 is dissolvable can be a same as the solvent to which the second adhesive layer 5, being formed from the second adhesive material made of the second adhesive compound whose average molecular weight is smaller than that of the adhesive compound in the first adhesive material, is dissolvable.

The removal method of the present invention allows the following, as described earlier. For removal of the support plate 3 from the wafer 2, the solvent is supplied to the second adhesive layer 5 via the through-hole in the support plate 3. As a result, the second adhesive layer can be dissolved in a short time. This makes it possible to remove the support plate 3, which is combined with the wafer 2 via the second adhesive layer 5. The first adhesive layer 4 is to be dissolved after removing the support plate 3. Therefore, the support plate 3 will not hinder diffusion of the solvent into the first adhesive layer 4. This makes it possible to dissolve the first adhesive layer 4 also in a quick way.

(Thermal Polymerization Inhibitor)

In the present invention, the adhesive composition for use in the first adhesive material or the second adhesive material can include a thermal polymerization inhibitor. The thermal polymerization inhibitor is a substance useful for inhibiting thermal radical polymerization reaction. Because the thermal polymerization inhibitor exhibits a high reactivity to a radical and responds quicker than does a monomer, it inhibits polymerization. As such, in the adhesive composition containing the thermal polymerization inhibitor, polymerization reaction of the adhesive composition under high-temperature environment (in particular, in a range from 250 to 350° C.) is inhibited. Thus, the adhesive composition can be dissolved even after being treated with a high-temperature process for 1 hour at 250° C. Therefore, the adhesive layer formed by the adhesive composition can be easily removed even after being treated with the high-temperature process. Furthermore, a residue of the second adhesive layer 5 can be prevented.

The thermal polymerization inhibitor is not particularly limited as long as being useful for inhibiting thermal radical polymerization. However, it is preferable that the thermal polymerization inhibitor be a phenol-type thermal polymerization inhibitor.

Examples of the thermal polymerization inhibitor encompass pyrogallol, benzoquinone, hydroquinone, methylene blue, tert-butylcatechol, monobenzyl ether, methyl hydroquinone, amylquinone, amyloxy hydroquinone, n-butylphenol, phenol, hydroquinone monopropyl ether, 4,4′-(1-methylethylidene)bis(2-mthylphenol), 4,4-(1-methyl ethylidene)bis(2,6-dimethylphenol), 4,4′-(1-(4-(1-(4-hydroquinone)-1-methylethyl)phenyl) ethylidene)bisphenol, 4,4′,4″-ethylidenetris(2-methylphenol), 4,4′,4″-ethylidenetrisphenol, 1,1,3-tris(2,5-dimethyl-4-hydroxyphenyl)-3-phenylpropane, 2,6-di-tert-butyl-4-methylphenol, 2,2′-methylenebis(4-methyl-6-tertbutylphenol), 4,4′-butyldenebis(3-methyl-6-tertbutylphenol), 4,4′-thiobis(3-methyl-6-tert butylphenol), 3,9-bis(2-(3-(3-tertbutyl-4-hydroxy-5-methylphenyl)-propionyloxy)-1,1-dimethylethyl)-2,4,8,10-tetraoxaspiro(5, 5)undecane, triethyleneglycol-bis-3-(3-tertbutyl-4-hydroxy-5-methylphenyl)propionate, n-octyl-3-(3,5-di-tertbutyl-4-hydroxylphenyl)propionate, pentaerythryltetrakis(3,5-di-tertbutyl-4-hydroxyphenyl) propionate) (product name IRGANOX1010, Ciba Speciality Chemicals. Inc), tris(3,5-di-tertbutylhydroxybenzyl)isocyanurate, thiodiethylenebis(3-(3,5-ditertbutyl-4-hydroxyphenyl) propionate). Among them, a phenol-type thermal polymerization inhibitor is preferable.

An amount of the thermal polymerization inhibitor to be contained in the adhesive composition should be determined as appropriate based on (i) a polymer of a main component as well as (ii) usage and use environment of the adhesive composition. However, it is preferable that the thermal polymerization inhibitor be contained in an amount ranging from 0.1 to 10.0 mass % with respect to the polymer of the major component. It is more preferable that the thermal polymerization inhibitor be contained in an amount ranging from 0.5 to 7.0 mass % with respect to the polymer of the major component. It is most preferable that the thermal polymerization inhibitor be contained in an amount ranging from 1.0 to 5.0 mass % with respect to the polymer of the major component. By setting the amount of the thermal polymerization inhibitor to any of the above ranges, it is possible to exercise a good inhibitory effect on thermal polymerization. This can make it further easier to remove the adhesive layer after treating it with the high-temperature process. Further, by setting the amount of the thermal polymerization inhibitor to any of the above ranges, it is possible to prevent a crack from being formed.

### EXAMPLES

Removal time for the support plate 3 was measured as a time period from start of initial pouring of the solvent to end of a process by which the support plate 3 was removed and all of the adhesive layers was dissolved away.

(Synthesis of Resin)

Each of resins 1 and 2 was synthesized by conventional radical polymerization in which materials were provided in amounts shown in Table 1 below.

TABLE 1

| | |
|---|---|
| Resin 1 | Resin 2 |

| | |
|---|---|
| Monomer | Amounts |

| | | |
|---|---|---|
| Methyl methacrylate | 10 | 10 |
| n-butyl methacrylate | 10 | 10 |
| Styrene | 52 | 52 |
| Isobornyl methacrylate | 5 | 5 |
| Dicyclopentanyl methacrylate | 13 | 13 |
| Mass average molecular weight | 40000 | 10000 |

In table 1, mass average molecular weight is mass average molecular weight based on standard styrene according to GPC measurement.

(Production of Adhesive Composition)

The resin 1 (100 parts by mass) was dissolved in PGMEA so as to prepare an adhesive composition 1 having a mass concentration of the resin 1 of 40 mass %. Further, the resin 2 (100 parts by mass) was dissolved in PGMEA so as to prepare an adhesive composition 2 having a mass concentration of the resin 2 of 40 mass %.

### Example 1

An adhesive compound 1 was applied onto a 5-inch silicon wafer 2 and then dried at 80° C. for 5 minutes, so as to form a first adhesive layer 4 having a film thickness of 15 μm. Subsequently, an adhesive compound 2 was applied onto the first adhesive layer 4 and then dried at 80° C. for 5 minutes, so as to form a second adhesive layer 5 having a film thickness of 3 μm. Then, a pored support plate 3 was attached on the second adhesive layer 5.

HP was poured onto a laminate 1 formed in the above way, from above the support plate 3. To HP, the second adhesive layer 5 had a solution rate of 200 nm/sec. After the second adhesive layer 5 was dissolved, the support plate 3 was removed, and HP was poured onto an entire surface of the first adhesive layer 4. To HP, the first adhesive layer had a solution rate of 100 nm/sec. It took approximately 60 seconds to dissolve the first adhesive layer 4, and approximately 2 minutes and 30 seconds to dissolve the support plate 3.

### Example 2

In a same way as Example 1, the adhesive compound 1 was applied onto a 5-inch silicon wafer 2, and dried at 80° C. for 5 minutes, so as to form a first adhesive layer 4 having a film thickness of 15 μm. On the first adhesive layer 4, subsequently, a solution of collagen peptide (a solution of collagen peptide having 30 mass %) was applied and dried at 80° C. for 5 minutes, so as to form a second adhesive layer 5 having a film thickness of 3 μm. Then, a pored support plate 3 was attached on the second adhesive layer 5.

Water was poured onto a laminate 1 formed in the above way, from above the support plate 3. To water, the second adhesive layer 5 had a solution rate of 340 nm/sec. After the second adhesive layer 5 was dissolved, the support plate 3 was removed, and HP was poured onto an entire surface of the first adhesive layer 4. To HP, the first adhesive layer 4 had a solution rate of 100 nm/sec. It took approximately 60 seconds to dissolve the first adhesive layer 4, and approximately 1 minute and 30 seconds to dissolve the support plate 3.

### Example 3

An adhesive compound 1 was applied onto a 6-inch silicon wafer 2 and dried at 110° C. for 3 minutes and then at 150° C. for 6 minutes, so as to form a first adhesive layer 4 having a film thickness of 30 μm. Subsequently, a p-menthane solution (30 mass %) containing a hydrogenerated terpene resin (YASUHARA CHEMICAL Co., Ltd) was applied onto the first adhesive layer 4 and dried at 120° C. for 3 minutes, so as to form a second adhesive layer 5 having a film thickness of 7 μm. Then, a pored support plate 3 was attached on the second adhesive layer 5.

p-menthane was poured onto a laminate 1 formed in the above way, from above the support plate 3. To p-menthane, the second adhesive layer 5 had a solution rate of 400 nm/s. After the second adhesive layer 5 was dissolved, the support plate 3 was removed, and HP was poured onto an entire surface of the first adhesive layer 4. To HP, the first adhesive layer had a solution rate of 100 nm/s. It took approximately 60 seconds to dissolve the first adhesive layer 4, and approximately 1 minute to remove the support plate 3.

### Examples 4 Through 24

The adhesive composition 1 was applied onto a 6-inch silicon wafer 2 and dried at 110° C. for 3 minutes and 150° C. for 6 minutes, so as to form a first adhesive layer 4 having a film thickness of 30 μm. Next, (i) a p-methane solution (30 mass %) containing only a polymer shown in each of Tables 2 through 4, (ii) a p-methane solution (30 mass %) containing only an oligomer shown in any of Tables 2 through 4, or (iii) a p-methane solution containing a mixture of the polymer and the oligomer, which solution was obtained by mixing them at a given ratio, was prepared. The p-methane solution was then applied onto the first adhesive layer 4 and dried at 120° C. for 3 minutes, so as to form a second adhesive layer 5 having a film thickness of 7 μm. Subsequently, a pored support plate was attached on the second adhesive layer 5.

In the present example, a cycloolefin copolymer (cycloolefin-ethylene A) produced by copolymerizing norborne and ethylene in the presence of a metallocene catalyst was a cycloolefin ethylene-type polymer A (TOPAS 8007 COC Polyplastics, Inc) which had: repeat units shown by the following general formulas (3) and (4) in a mass ratio of 35:65; Tg of 70° C.; mass average molecular weight (Mw) of 98200; a dispersivity (Mw/Mn) of 1.69; and a softening point of 70° C.

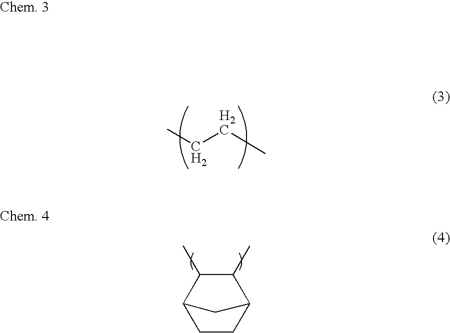

Furthermore, the oligomer was (i) a terpene resin A (YASUHARA CHEMICAL Co., Ltd. Clearon P135, hydrogenerated terpene resin) having a softening point of 135° C. and molecular weight of 820, (ii) a terpene resin B (YASUHARA CHEMICAL Co., Ltd. Clearon P115, hydrogenerated terpene resin) having a softening point of 115° C. and molecular weight of 650, or (iii) a terpene resin C (YASUHARA CHEMICAL Co., Ltd. Clearon P105, hydrogenerated terpene resin) having a softening point of 105° C. and molecular weight of 630.

Each of the laminates 1 produced in the above way was tested for the following points. Table 2 shows the results.

TABLE 2

| | | | | Exam- | Exam- | Exam- | Exam- | Exam- | Exam- | Exam- |
|---|---|---|---|---|---|---|---|---|---|---|
| | | | | ple 4 | ple 5 | ple 6 | ple 7 | ple 8 | ple 9 | ple 10 |
| Polymer | | Cycloolefin-ethylene A (wt %) | | 100 | 75 | 65 | 58 | 50 | 35 | 0 |
| Oligomer | | Terpene resin A (wt %) | | 0 | 25 | 35 | 42 | 50 | 65 | 100 |
| Points | Dissolubility | dissolubility to hydrocarbon-type solvent | | ∘ | ∘ | ∘ | ∘ | ∘ | ∘ | ∘ |
| | | (p-menthane) | | | | | | | | |
| | | dissolution rate to p-menthane (nm/s) | | 51.4 | 67 | 84.2 | 90 | 101 | 240 | 490 |
| | Thermal-Resistant | dissolubility to p-menthane after | | ∘ | ∘ | ∘ | ∘ | ∘ | ∘ | ∘ |
| | Dissolubility | heating at 200° C. for 60 min | | | | | | | | |
| | Crack Resistance | presence of absence of crack after | | ∘ | ∘ | ∘ | ∘ | x | x | x |
| | | Dipping with PGMEA solution | | | | | | | | |
| | | (at 23° C. for 5 min) | | | | | | | | |
| | Application | presence or absence of crack after | | ∘ | ∘ | ∘ | ∘ | x | x | x |
| | Dissolubility | 50 μm application (150° C. for 3 min, | | | | | | | | |
| | (Flexibility) | then 200° C. for 3 min) | | | | | | | | |
| | Solvent | presence or absence of crack | H₂O | ∘ | ∘ | ∘ | ∘ | ∘ | ∘ | ∘ |
| | Dissolubility | after Dipping (23° C. for 5 min) | IPA | ∘ | ∘ | ∘ | ∘ | ∘ | ∘ | ∘ |
| | | | PGME | ∘ | ∘ | ∘ | ∘ | ∘ | ∘ | ∘ |
| | | | NMP | ∘ | ∘ | ∘ | ∘ | ∘ | ∘ | ∘ |
| | | | DMSO | ∘ | ∘ | ∘ | ∘ | ∘ | ∘ | ∘ |
| | | | TMAH (2.38%) | ∘ | ∘ | ∘ | ∘ | ∘ | ∘ | ∘ |
| | | | NaOH | ∘ | ∘ | ∘ | ∘ | ∘ | ∘ | ∘ |
| | | | HF 1%, 3% | ∘ | ∘ | ∘ | ∘ | ∘ | ∘ | ∘ |

| | | | | | | | | |
|---|---|---|---|---|---|---|---|---|
| Degasifying | TDS: Intensity of 10000 or lower at 200° C. | ∘ | ∘ | ∘ | ∘ | ∘ | ∘ | x |
| Thermal Resistance | presence or absence of breakdown | ∘ | ∘ | ∘ | ∘ | ∘ | ∘ | ∘ |
| | at 200° C. or lower | | | | | | | |

TABLE 3

| | | | | Exam- | Exam- | Exam- | Exam- | Exam- | Exam- | Exam- |
|---|---|---|---|---|---|---|---|---|---|---|
| | | | | ple 11 | ple 12 | ple 13 | ple 14 | ple 15 | ple 16 | ple 17 |
| Polymer | | Cycloolefin-ethylene A (wt %) | | 100 | 75 | 65 | 58 | 50 | 35 | 0 |
| Oligomer | | Terpene resin B (wt %) | | 0 | 25 | 35 | 42 | 50 | 65 | 100 |
| Points | Dissolubility | dissolubility to hydrocarbon-type solvent | | ∘ | ∘ | ∘ | ∘ | ∘ | ∘ | ∘ |
| | | (p-menthane) | | | | | | | | |
| | | dissolution rate to p-menthane (nm/s) | | 51.4 | 82.5 | 97 | 99 | 102 | 250 | 500 |
| | Thermal-Resistant | dissolubility to p-menthane after | | ∘ | ∘ | ∘ | ∘ | ∘ | ∘ | ∘ |
| | Dissolubility | heating at 200° C. for 60 min | | | | | | | | |
| | Crack Resistance | presence of absence of crack after | | ∘ | ∘ | ∘ | ∘ | x | x | x |
| | | Dipping with PGMEA solution | | | | | | | | |
| | | (at 23° C. for 5 min) | | | | | | | | |
| | Application | presence or absence of crack after | | ∘ | ∘ | ∘ | ∘ | x | x | x |
| | Dissolubility | 50 μm application (150° C. for 3 min, | | | | | | | | |
| | (Flexibility) | then 200° C. for 3 min) | | | | | | | | |
| | Solvent | presence or absence of crack | H₂O | ∘ | ∘ | ∘ | ∘ | ∘ | ∘ | ∘ |
| | Dissolubility | after Dipping (23° C. for 5 min) | IPA | ∘ | ∘ | ∘ | ∘ | ∘ | ∘ | ∘ |
| | | | PGME | ∘ | ∘ | ∘ | ∘ | ∘ | ∘ | ∘ |
| | | | NMP | ∘ | ∘ | ∘ | ∘ | ∘ | ∘ | ∘ |
| | | | DMSO | ∘ | ∘ | ∘ | ∘ | ∘ | ∘ | ∘ |
| | | | TMAH (2.38%) | ∘ | ∘ | ∘ | ∘ | ∘ | ∘ | ∘ |
| | | | NaOH | ∘ | ∘ | ∘ | ∘ | ∘ | ∘ | ∘ |
| | | | HF 1%, 3% | ∘ | ∘ | ∘ | ∘ | ∘ | ∘ | ∘ |

| | | | | | | | | |
|---|---|---|---|---|---|---|---|---|
| Degasifying | TDS: Intensity of 10000 or lower at 200° C. | ∘ | ∘ | ∘ | ∘ | ∘ | ∘ | x |
| Thermal Resistance | presence or absence of breakdown | ∘ | ∘ | ∘ | ∘ | ∘ | ∘ | ∘ |
| | at 200° C. or lower | | | | | | | |

TABLE 4

| | | | | Exam- | Exam- | Exam- | Exam- | Exam- | Exam- | Exam- |
|---|---|---|---|---|---|---|---|---|---|---|
| | | | | ple 18 | ple 19 | ple 20 | ple 21 | ple 22 | ple 23 | ple 24 |
| Polymer | | Cycloolefin-ethylene A (wt %) | | 100 | 75 | 65 | 58 | 50 | 35 | 0 |
| Oligomer | | Terpene resin C (wt %) | | 0 | 25 | 35 | 42 | 50 | 65 | 100 |
| Points | Dissolubility | dissolubility to hydrocarbon-type solvent | | ∘ | ∘ | ∘ | ∘ | ∘ | ∘ | ∘ |
| | | (p-menthane) | | | | | | | | |
| | | dissolution rate to p-menthane (nm/s) | | 51.4 | 80 | 109 | 114 | 130 | 272 | 520 |
| | Thermal-Resistant | dissolubility to p-menthane after | | ∘ | ∘ | ∘ | ∘ | ∘ | ∘ | ∘ |
| | Dissolubility | heating at 200° C. for 60 min | | | | | | | | |
| | Crack Resistance | presence of absence of crack after | | ∘ | ∘ | ∘ | ∘ | x | x | x |
| | | Dipping with PGMEA solution | | | | | | | | |
| | | (at 23° C. for 5 min) | | | | | | | | |
| | Application | presence or absence of crack after 50 μm | | ∘ | ∘ | ∘ | ∘ | x | x | x |
| | Dissolubility | application (150° C. for 3 min, | | | | | | | | |
| | (Flexibility) | then 200° C. for 3 min) | | | | | | | | |
| | Solvent | presence or absence of crack | H₂O | ∘ | ∘ | ∘ | ∘ | ∘ | ∘ | ∘ |
| | Dissolubility | after Dipping (23° C. for 5 min) | IPA | ∘ | ∘ | ∘ | ∘ | ∘ | ∘ | ∘ |
| | | | PGME | ∘ | ∘ | ∘ | ∘ | ∘ | ∘ | ∘ |
| | | | NMP | ∘ | ∘ | ∘ | ∘ | ∘ | ∘ | ∘ |
| | | | DMSO | ∘ | ∘ | ∘ | ∘ | ∘ | ∘ | ∘ |
| | | | TMAH (2.38%) | ∘ | ∘ | ∘ | ∘ | ∘ | ∘ | ∘ |
| | | | NaOH | ∘ | ∘ | ∘ | ∘ | ∘ | ∘ | ∘ |
| | | | HF 1%, 3% | ∘ | ∘ | ∘ | ∘ | ∘ | ∘ | ∘ |

| | | | | | | | | |
|---|---|---|---|---|---|---|---|---|
| Degasifying | TDS: Intensity of 10000 or lower at 200° C. | ∘ | ∘ | ∘ | ∘ | ∘ | ∘ | x |
| Thermal Resistance | presence or absence of breakdown at | ∘ | ∘ | ∘ | ∘ | ∘ | ∘ | ∘ |
| | 200° C. or lower | | | | | | | |

(Evaluation of Dissolubility to Hydrocarbon-type Solvent)

Each of the laminates 1 was immersed in p-menthane (at 23° C. for 5 minutes). As to the dissolubility to Hydrocarbon-type solvent, “O” indicates that the second adhesive layer 5 was completely dissolved after immersion in p-menthane, whereas “x” indicates that the adhesive layer 5 was not completely dissolved after the immersion in p-menthane. Further, when the second adhesive layer 5 was completely dissolved, a dissolution rate (nm/sec) was worked out based on a relation between a film thickness and a dissolution time. A dissolution rate of 60 nm/sec was preferable in view of productivity.

In each of Examples 2 through 24, the second adhesive layer 5 was completely dissolved in p-methane, as shown in Tables 2 through 4. The dissolution rate was in a range from 51.4 to 520 nm/sec.

(Evaluation of Thermal Resistant Dissolubility)

Each of the laminates 1 was heated at 230° C. for 1 hour, and then immersed in p-menthane. After immersion in p-menthane, it was visually observed whether the second adhesive layer 5 was dissolved or not. “O” indicates that the second adhesive layer 5 was completely dissolved, whereas “x” indicates that the adhesive layer 5 was not completely dissolved.

In each of Examples 3 through 24, the second adhesive layer 5 treated with heating was dissolved in p-menthane, as shown in Tables 2 through 4. In each of Examples 3, 5 through 10, 12 through 17, and 19 through 24, the dissolution rate of the second adhesive layer 5 was 60 nm/sec as shown in Tables 2 through 4. Such dissolution rate was preferable in view of productivity.

(Evaluation of Crack Resistance)

Each of the laminates 1 was immersed in PGMEA (at 23° C. for 5 minutes). After immersion in PGMEA, it was visually observed whether a crack was formed in the second adhesive layer 5 or not. “O” indicates that no crack was formed, whereas “x” indicates that the crack was formed.

In each of Examples 4 through 7, 11 through 14, and through 21, no crack was formed in the second adhesive layer 5, as shown in Tables 2 through 4. In each of Examples 8 through 10, 15 through 17, and 22 through 24, on the other hand, the crack was formed in the second adhesive layer 5.

(Evaluation of Flexibility)

It was visually observed whether the crack was formed in the second adhesive layer 5 formed in each of the laminates 1 in such a manner as to have a film thickness of 50 μm. “O” indicates that no crack was formed, whereas “x” indicates that the crack was formed.

In each of Examples 4 through 7, 11 through 14, and through 21, no crack was formed in the second adhesive layer 5, as shown in Tables 2 through 4. As such, the second adhesive layer 5 had a good flexibility after being formed by applying the second adhesive material. In each of Examples 8 through 10, 15 through 17, and 22 through 24, on the other hand, the crack was formed in the second adhesive layer 5.

(Evaluation of Dissolvent Resistance)

Each of the laminates 1 was immersed in each of water, IPA (isopropyl alcohol), PGME (propyleneglycolmonomethyl ether), NMP (N-methyl pyrolidone), DMSO (dimethyl sulfoxide), 2.38 mass % TMAH water solution, 5 mass % aqueous sodium hydroxide, 1 mass % hydrofluoric acid, and 3 mass % hydrofluoric acid (at 23° C. for 5 minutes). After immersion in each solvent, it was visually observed whether a crack was formed in the second adhesive layer 5 or not as well as whether the second adhesive layer 5 was dissolved or not. “O” indicates that no crack was formed in the second adhesive layer 5 and the second adhesive layer 5 was not dissolved, whereas “x” indicates that the crack was formed in the second adhesive layer 5 and the second adhesive layer was dissolved.

In each of Examples 4 through 7, 11 through 14, and 18 through 21, (i) no crack was formed in the second adhesive layer 5 and (ii) the second adhesive layer 5 was not dissolved, after immersion in each solvent. Thus, the second adhesive layer had a good resistance to a solvent. In each of Examples 8 through 10, 15 through 17, and 22 through 24, a crack was formed in the second adhesive layer 5.

(Evaluation of Degassing Amount and Thermal Resistance)

Each of laminates 1 was heated from 40 to 250° C., and an amount (degassing amount) of a gas generated in the second adhesive layer 5 was evaluated. A thermal resistance of each of adhesive compositions 2 was evaluated based on the amount of the gas.

A reason why the thermal resistance can be evaluated based on the degassing amount was as follows. That is, the degassing amount measured below 100° C. was derived from a water vapor or an azeotropic gas thereof. The water vapor and the azeotropic gas thereof were derived from moisture absorbed into the adhesive composition 2. On the other hand, the degassing amount measured at 100° C. or higher was derived from a gas being generated as the adhesive composition 2 was broken down by heating. Therefore, the thermal resistance of the adhesive composition 2 can be evaluated based on the degassing amount measured at temperature in a range of 100° C. or higher, in particular, at temperature around 200° C.

The degassing amount was measured by using a TDS method (Thermal Desorption Spectroscopy method, thermal desorption analysis method). A TDS measurement device (emission gas measurement device) was EMD-WA 1000 (ESCO, Ltd). Measurement conditions for the TDS measurement device were Width: 100, Center Mass Number: 50, Gain: 9, Scan Speed: 4, and Emult Volt: 1.3 kV.

In evaluation of the degassing amount, “O” indicated that an intensity required for the TDS measurement device at 200° C. was less than 10000, whereas “x” indicated that the intensity required for the TDS measurement device at 200° C. was 10000 or greater.

In evaluation of the thermal resistance, “O” indicated (i) the intensity required by the TDS measurement device at 200° C. was less than 10000 and (ii) no residue was observed with a metal microscope, “Δ” indicated that (iii) the intensity required by the TDS measurement device was 10000 or greater and (iv) a residue was observed with the metal microscope, and “x” indicated that (v) the intensity required by the TDS measurement device was 10000 or greater and (vi) the residue was observed with the metal microscope.

In each of Examples 4 through 9, 11 through 16, and 18 through 23, the degassing amount and the thermal resistance were evaluated to be good, as shown in Tables 2 through 4.

### Examples 25 and 26

The adhesive composition 2 of Example 4 was added with a thermal polymerization inhibitor (IRGANOX1010 (Ciba Speciality Chemicals, Inc)) in such a manner that a proportion of the thermal polymerization inhibitor to a total of the resin in the adhesive composition 2 would be 1% or 5%. This constituted Examples 25 and 26. On the first adhesive layer 4 formed in Example 3, a second adhesive layer 5 was formed by using any of the adhesive compositions in Examples 4, 25, and 26. Subsequently, a pored support plate was attached on the second adhesive layer 5, and this produced the laminate 1.

Each of the laminates 1 was heated at 250° C. for 1 hour, and then immersed in p-menthane. After immersion in p-menthane, a dissolution rate (nm/sec) of the second adhesive layer 5 was worked out. Table 5 shows the results.

TABLE 5

| | Rate at which | | |
|---|---|---|---|
| | thermal | Dissolution | Dissolution rate |
| | polymerization | rate before | after heating at |
| | inhibitor is | heating | 250° C. for 1 hour |
| | contained | (nm/sec) | (nm/sec) |
| Example 4 | 0% | 58 | Indissoluble at |
| | | | 240° C. |
| Example 25 | 1% | 50 | Indissoluble at |
| | | | 250° C. |
| Example 26 | 5% | 56 | 60 |

In each of Examples 4, 25, and 26, the dissolution rate worked out before heating was in a range from 50 to 58 nm/sec, as shown in Table 5. In each of Examples 4 and 25, the second adhesive layer 5 heated at temperature ranging from 240 to 250° C. became indissoluble. In Example 26, on the other hand, the dissolution rate of the second adhesive layer treated with heating was 60 nm/sec. Thus, the thermal resistance was improved by adding the thermal polymerization inhibitor.

### Reference Example 1

In a same way as Example 1, an adhesive composition 1 was applied onto a 5-inch silicon wafer 2 and dried at 80° C. for 5 minutes, so a to form an adhesive layer having a film thickness of 15 μm. Subsequently, a pored support plate 3 was attached on the adhesive layer. That is, it was configured such that the adhesive layer had a single layer. HP was poured onto a laminate produced in this way from above the support plate 3. To HP, the adhesive layer had a dissolution rate of 100 nm/sec. However, because the solvent was supplied via through-hole in the support plate 3, a diffusion rate of the solvent was deteriorated, and it took approximately 5 minutes to dissolve the adhesive layer. In other words, a removal time of the support plate 3 was approximately 5 minutes.

The present invention is not limited to the description of the embodiments above, but may be altered by a skilled person within the scope of the claims. An embodiment based on a proper combination of technical means disclosed in different embodiments and examples is encompassed in the technical scope of the present invention.

### INDUSTRIAL APPLICABILITY

With the removal method of the present invention, it is possible to remove a support plate from a substrate in a short time. As such, the removal method of the present invention is suitably applicable to, for example, production of a miniaturized semiconductor device.

### REFERENCE SIGNS LIST

1. Laminate
2. Wafer (substrate)
3. Support plate
4. First adhesive layer
5. Second adhesive layer
6. Adhesive laminate

1. A removal method for removing a support plate from a substrate, the removal method comprising:
providing the support plate and the substrate being combined to each other via a first adhesive layer and a second adhesive layer, the second adhesive layer being (i) an adhesive layer which is dissolvable in a solvent quicker than the first adhesive layer or (ii) an adhesive layer which is dissolvable in a solvent different from a solvent to which the first adhesive layer is dissolvable, and the second adhesive layer being between the support plate and the first adhesive layer; and
removing the support plate from the substrate by dissolving the second adhesive layer.

2. The removal method as set forth in claim 1, further comprising, after the step of removing:
dissolving the first adhesive layer.

3. The removal method as set forth in claim 1, wherein the support plate has a plurality of through-holes in a film thickness direction.

4. The removal method as set forth in claim 1, wherein
the second adhesive layer is formed by an adhesive compound which has an average molecular weight corresponding to 10 to 30% of an average molecular weight of an adhesive compound constituting the first adhesive layer.

5. The removal method as set forth in any one of claim 1, wherein the second adhesive layer is formed from an adhesive compound, the adhesive compound being a hydrocarbon resin or a polar-solvent dissolvable compound.

6. The removal method as set forth in claim 5, wherein the hydrocarbon resin is a cycloolefin copolymer or a cycloolefin polymer.

7. The removal method as set forth in claim 5, wherein the polar-solvent dissolvable compound is selected from the group consisting of collagen peptide, cellulose, and polyvinyl alcohol (PVA).

8. The method as set forth in any one of claim 1, wherein the second adhesive layer has a film thickness thinner than a film thickness of the first adhesive layer.

9. A laminate, comprising:
a substrate;
a first adhesive layer formed on the substrate;
a second adhesive layer formed on the first adhesive layer, the second adhesive layer being (i) an adhesive layer which is dissolvable in a solvent quicker than the first adhesive layer or (ii) an adhesive layer which is dissolvable in a solvent different from a solvent to which the first adhesive layer is dissolvable; and
a support plate attached on the second adhesive layer.

10. An adhesive agent for constituting the second adhesive layer included in a laminate as set forth in claim 9.

11. The adhesive agent as set forth in claim 10, containing an adhesive compound whose average molecular weight is in a range from 5000 to 10000.

12. The adhesive agent as set forth in claim 10, being made of a hydrocarbon resin or a polar-solvent dissolvable compound.

13. The adhesive agent as set forth in claim 12, wherein the hydrocarbon resin is selected from the group consisting of a cycloolefin-type polymer, a terpene resin, a rosin-type resin, and a petroleum resin.

14. The adhesive agent as set forth in claim 12, wherein the polar-solvent dissolvable compound is selected from the group consisting of collage peptide, cellulose, and polyvinyl alcohol (PVA).
